(19) United States
(12) Patent Application Publication
(10) Pub. No.: US 2009/0284596 A1
(43) Pub. Date: Nov. 19, 2009

(54) INFRARED SURVEILLANCE CAMERA HAVING DETACHABLE LIGHTING DEVICE ROTATABLE WITH CAMERA LENS

(75) Inventor: Sung-Ken Lin, Taipei City (TW)

Correspondence Address: Sung-Ken, Lin, P.O.BOX 46-563, Taipei, Taipei City, 10499, TW

(73) Assignee: CAMDEOR TECHNOLOGY CO., LTD., Taipei City (TW)

(21) Appl. No.: 12/465,660

(22) Filed: May 14, 2009

(30) Foreign Application Priority Data
May 19, 2008 (TW) 097118379
Oct. 6, 2008 (TW) 097138428
Apr. 21, 2009 (TW) 098113221

(51) Int. Cl. H04N 7/18; H04N 5/33

(52) U.S. Cl. 348/143; 348/E07.085; 348/164; 348/E05.09

(57) ABSTRACT

An infrared surveillance camera essentially includes a base, a camera lens, a horizontal rotation device, a vertical rotation device, a transparent cover, a shielding cover, at least one lighting device, and at least one connector. The shielding cover is provided in the base and configured for shielding components received in the base. The at least one lighting device is connected to the camera lens by the at least one connector so as to rotate with the camera lens, thereby providing supplementary illumination and enhancing the quality of images captured with the camera lens.

### BACKGROUND OF THE INVENTION

1. Technical Field

The present invention relates to infrared surveillance cameras and, more particularly, to a surveillance camera having a detachable lighting device rotatable with a camera lens so as to enhance the quality of images captured with the camera lens.

2. Description of Related Art

Referring to FIG. 1 and FIG. 2, a conventional surveillance camera 1 typically has a lens 11 peripherally provided with a plurality of light-emitting diodes (LEDs) 12. While the surveillance camera 1 continuously captures images with the lens 11, if ambient brightness falls or the light source depended upon becomes insufficient, the LEDs 12 surrounding the lens 11 will be turned on immediately to provide supplementary illumination. However, as the LEDs 12 are arranged around the lens 11, light emitted by the LEDs 12 will interfere with the lens 11 and significantly lower the quality of images captured with the lens 11. Furthermore, since the LEDs 12 are located inside the surveillance camera 1, the number of the LEDs 12 cannot be increased or decreased according to the location where the surveillance camera 1 is used, and maintenance of the LEDs 12 is also made difficult. Moreover, when the surveillance camera 1 is used during nighttime, the light emitted by the LEDs 12 may attract mosquitoes or other insects which, when flying in front the lens 11, may obscure the lens 11 and impair the resultant image quality. In addition, after long-term use, the surveillance camera 1 may be invaded by moisture or other foreign matters that cloud the lens 11 or eventually damage the internal components of the LEDs 12.

### BRIEF SUMMARY OF THE INVENTION

A primary objective of the present invention is to provide a surveillance camera essentially including a base, a camera lens, a horizontal rotation device, a vertical rotation device, a transparent cover, a shielding cover, at least one lighting device, and at least one connector. The at least one lighting device is connected to the camera lens by the at least one connector so as to rotate with the camera lens, thereby enhancing the quality of images captured with the camera lens.

A secondary objective of the present invention is to provide the foregoing surveillance camera wherein the shielding cover is located in the base and configured for covering components accommodated in the base so that foreign matters or moisture is prevented from entering the base and damaging the components.

Another objective of the present invention is to provide the foregoing surveillance camera wherein the at least one lighting device is individually mounted outside the transparent cover and is detachable from the at least one connector. Therefore, depending on the location or environment where the surveillance camera is installed, the surveillance camera may be connected with two or only one such lighting device with the desired illumination intensity, thereby achieving convenience of use.

Yet another objective of the present invention is to provide the foregoing surveillance camera wherein the at least one lighting device is individually mounted outside the transparent cover and separated from the camera lens. Thus, the impact of light emitted by the at least one lighting device on the camera lens is significantly reduced, allowing the surveillance camera to capture high quality images with the camera lens.

Still another objective of the present invention is to provide the foregoing surveillance camera wherein the at least one lighting device is individually mounted outside the transparent cover and separated from the camera lens so that even after long-term use, the camera lens is still well protected from being affected or damaged by heat generated from the at least one lighting device during illumination. In addition, as the camera lens is covered with the transparent cover, the performance of the camera lens will not be affected or damaged by moisture condensation that arises from heat generated by the at least one lighting device.

### BRIEF DESCRIPTION OF THE SEVERAL VIEWS OF THE DRAWINGS

The invention as well as a preferred mode of use, further objectives, and advantages thereof will be best understood by referring to the following detailed description of illustrative embodiments in conjunction with the accompanying drawings, wherein:

FIG. 1 is a perspective view of a conventional surveillance camera;

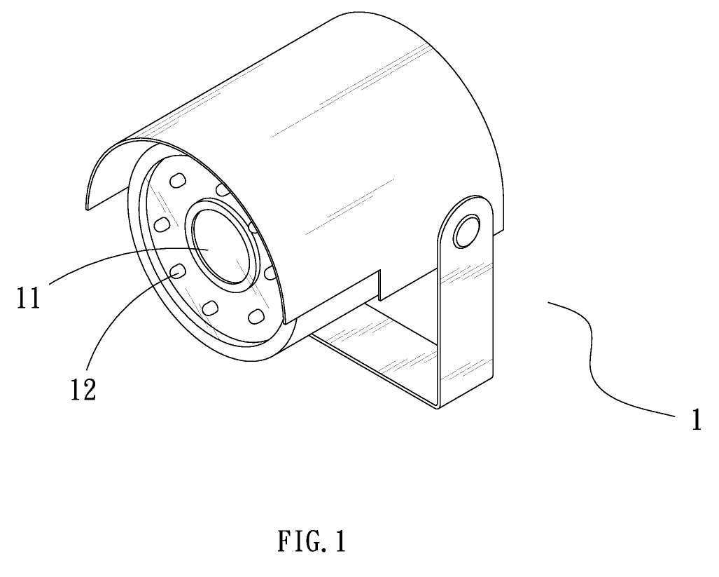

FIG. 2 is a perspective view showing operation of the conventional surveillance camera;

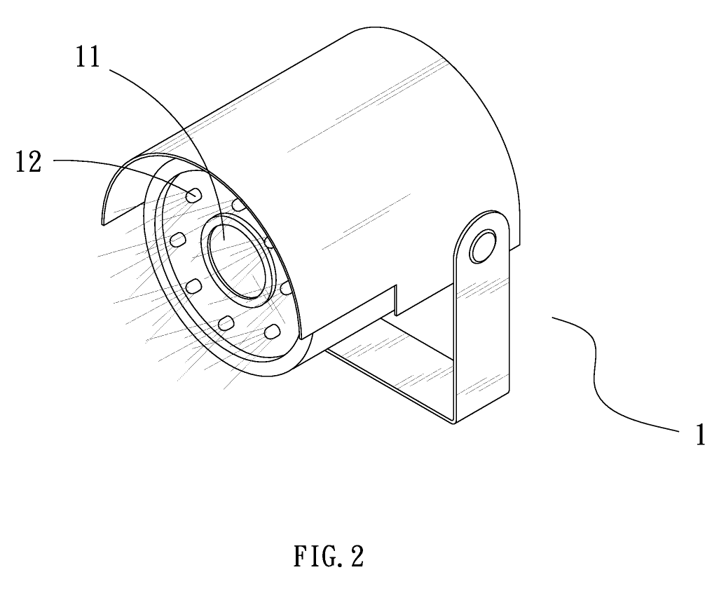

FIG. 3 is an assembled perspective view of a surveillance camera according to the present invention;

FIG. 4 is an exploded perspective view of the surveillance camera according to the present invention;

FIG. 5 is a partially see-through view showing a preferred embodiment of the present invention;

FIG. 6 is a perspective view showing operation of the preferred embodiment of the present invention;

FIG. 7 is another perspective view showing operation of the preferred embodiment of the present invention; and

FIG. 8 is a perspective view showing another embodiment of the present invention.

### DETAILED DESCRIPTION OF THE INVENTION

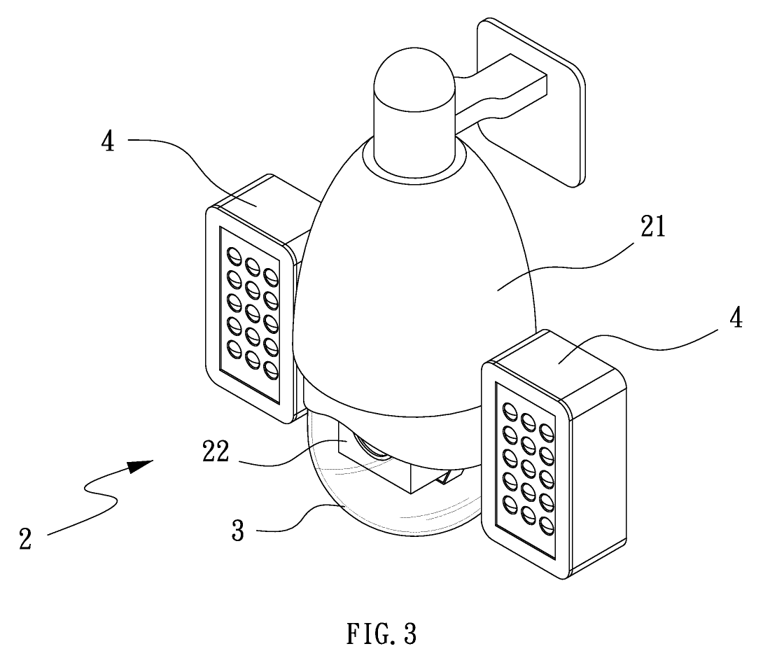

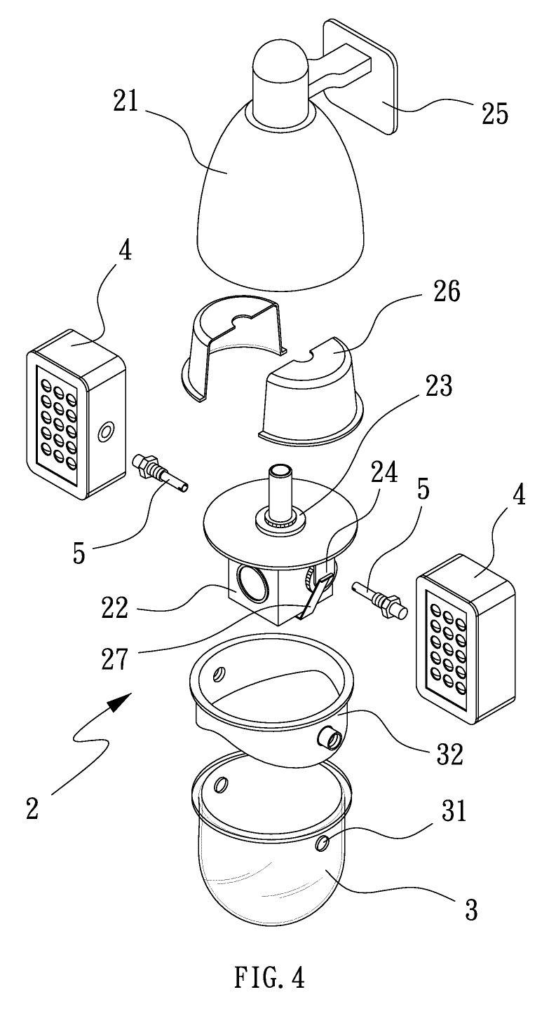

Please refer to FIG. 3 and FIG. 4 for an assembled perspective view and an exploded perspective view of an infrared surveillance camera 2 according to the present invention that is capable of achieving the aforementioned objectives and effects. The surveillance camera 2 essentially includes a base 21, a camera lens 22, a horizontal rotation device 23, a vertical rotation device 24, a shielding cover 26, a transparent cover 3, at least one lighting device 4 including a plurality of arrayed LEDs, and at least one connector 5. The camera lens 22 is provided on the base 21 and is rotatable to the desired shooting angles by the horizontal rotation device 23 and the vertical rotation device 24 installed in the base 21. Provided at the opposite end of the base 21 is a fixing element 25. The shielding cover 26 is disposed in the base 21 and configured for covering components received in the base 21. The transparent cover 3 is provided on the base 21 and covers the camera lens 22. Furthermore, the transparent cover 3 is formed with at least one through hole 31 for being inserted by the at least one connector 5, respectively. In addition, a shell 32 is mounted around the transparent cover 3 to reinforce the transparent cover 3. Each of the at least one connector 5 has an end connected with the camera lens 22 inside the transparent cover 3 and an opposite end connected with one of the at least one lighting device 4. Thus, the at least one lighting device 4 is mounted individually outside the transparent cover 3, and by virtue of the connection provided by the at least one connector 5, the at least one lighting device 4, as well as the illumination direction thereof, is rotatable with the camera lens 22.

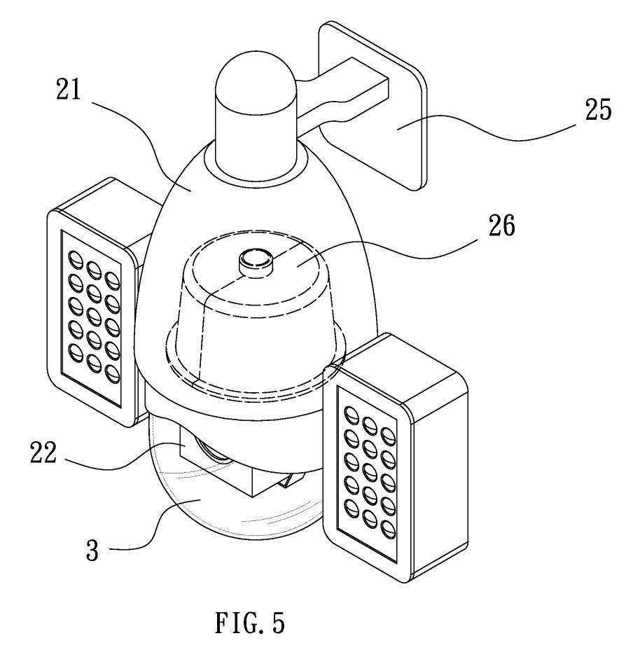

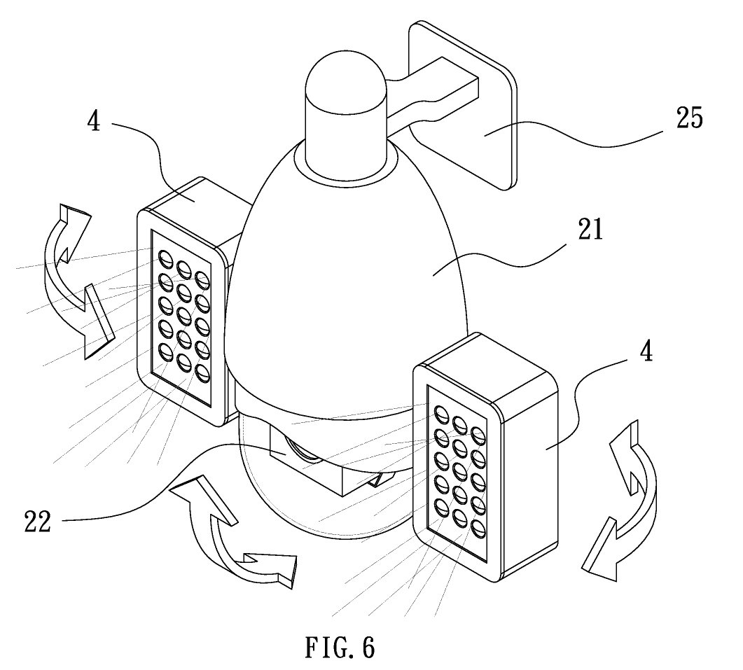

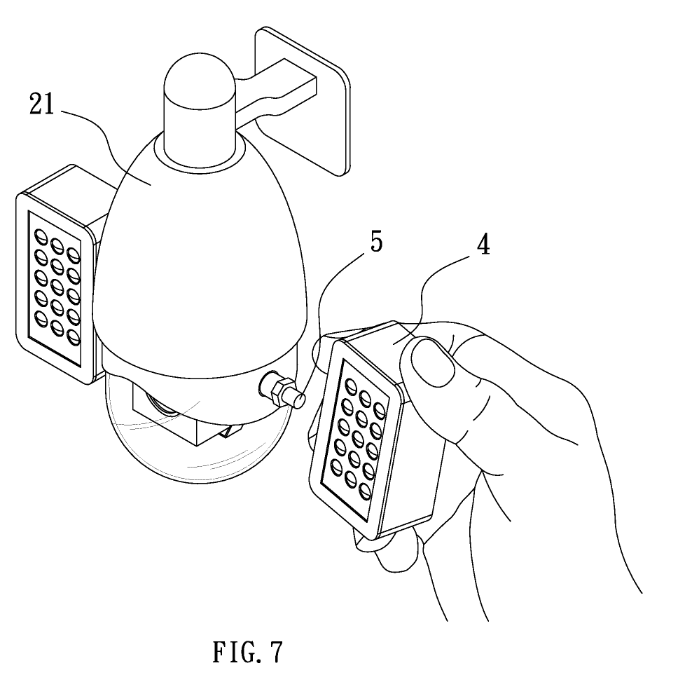

Please refer to FIGS. 5 through 7 (in conjunction with FIG. 4) for a preferred embodiment of the present invention. As shown in the drawings, the surveillance camera 2 is installed on a wall, a ceiling, or a specific object via the fixing element 25 at the end of the base 21. When the surveillance camera 2 starts to capture images continuously, the camera lens 22 as well as the shooting direction thereof is rotated by the rotation devices 23 and 24 in the base 21. And while the camera lens 22 is rotated, the lighting devices 4 are also rotated with the camera lens 22 by means of the connectors 5 which connect the camera lens 22 with the lighting devices 4 outside the transparent cover 3, thus allowing the lighting devices 4 to provide supplementary illumination in the shooting direction of the camera lens 22. Furthermore, as the lighting devices 4 are mounted individually outside the transparent cover 3 and are detachable from the connectors 5, the surveillance camera 2 may be equipped with two such lighting devices 4, as shown in FIGS. 5 to 7, or with only one such lighting device 4, depending on the environment where the surveillance camera 2 is installed. In order to obtain optimal image quality with the camera lens 22, the lighting devices 4 in use are replaceable by their equivalents having higher or lower illumination intensities. Besides, the shielding cover 26 ( [symbol] 25) in the base 21 serves to cover and thus protect the components received in the base 21 from being damaged by foreign matters or moisture which might otherwise enter the base 21.

By mounting the lighting devices 4 individually outside the transparent cover 3, not only is a user allowed to replace the lighting devices 4 on his or her own so as to facilitate use and maintenance, but also the camera lens 22 is protected from being interfered and damaged by the light and heat generated by the lighting devices 4. As previously mentioned, such interference and damage are likely to happen in the conventional surveillance camera 1 wherein the lens 11 is surrounded by the LEDs 12, whose light and heat are detrimental to both image quality and the surveillance camera 1 itself.

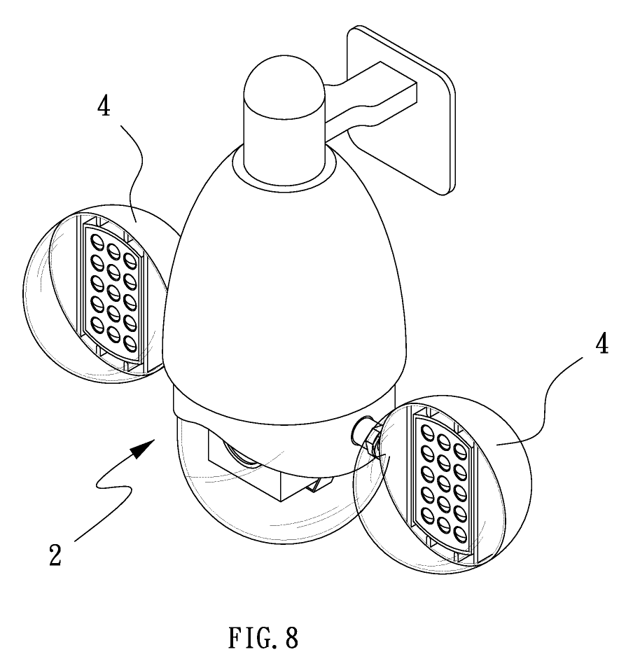

FIG. 8 shows a further embodiment of the present invention, wherein the lighting devices 4 of the surveillance camera 2 have a circular shape. Alternatively, the lighting devices 4 may have a square or oblong shape to suit the location where the surveillance camera 2 is installed or to reduce aerodynamic drag.

In conclusion, the present invention provides the following advantages over the prior art devices:

1. The lighting devices 4 are individually mounted so as to minimize the adverse effect of light emitted therefrom on the camera lens 22 and thus increase the quality of images captured with the camera lens 22.

2. The lighting devices 4 are separated from the camera lens 22 so as to prevent the camera lens 22 from being obscured at night by mosquitoes or other insects that are attracted toward the surveillance camera 4 by the light emitted from the lighting devices 4.

3. As the lighting devices 4 are each provided with a plurality of arrayed LEDs, and the LEDs generate high heat during illumination, the lighting devices 4 according to the present invention are individually mounted so as to prevent the heat generated by the LEDs from damaging the camera lens 22 and related components in the surveillance camera 2. Also, moisture condensation resulting from the high heat will not directly affect the quality of images taken with the camera lens 22, and there is no need to worry that the camera lens 22 and related components in the surveillance camera 2 will be damaged by moisture condensation.

4. The shielding cover 26 is additionally provided in the base 21 so as to cover the components accommodated in the base 21. In consequence, foreign matters or moisture is prevented from entering the base 21 and damaging the components therein.

5. The lighting devices 4 are detachable structures so that, depending on the location and environment where the surveillance camera 2 is installed, the surveillance camera 2 may be mounted with two or only one such lighting device 4, and the lighting devices 4 in use are replaceable by their equivalents having the desired illumination intensities, thus achieving convenience of use.

1. An infrared surveillance camera, comprising:
a base;
a camera lens provided on the base;
a horizontal rotation device provided in the base;
a vertical rotation device provided in the base;
a shielding cover provided in the base and configured for covering components received in the base;
a transparent cover provided on the base and covering the camera lens;
at least a lighting device provided outside the transparent cover; and
at least a connector for connecting the camera lens with the at least a lighting device;
wherein the at least a connector connects the at least a lighting device to the camera lens such that when the camera lens is rotated by the horizontal rotation device and the vertical rotation device, the at least a lighting device is rotated along with the camera lens so as to provide supplementary illumination effectively while the shielding cover covering the components received in the base prevents foreign matters from entering the base.

2. The infrared surveillance camera of claim 1, wherein each said lighting device comprises a plurality of arrayed light-emitting diodes.

3. The infrared surveillance camera of claim 1, wherein each said lighting device has a square, oblong, or circular shape.

4. The infrared surveillance camera of claim 1, wherein the transparent cover is formed with at least a through hole for being inserted by the at least a connector, respectively.

5. The infrared surveillance camera of claim 1, wherein the base has an end provided with a fixing element.

6. The infrared surveillance camera of claim 1, wherein a shell is further mounted around the transparent cover to reinforce the transparent cover.

7. The infrared surveillance camera of claim 1, wherein a support is additionally provided for supporting and carrying the camera lens.
